(19) United States
(12) Patent Application Publication
(10) Pub. No.: US 2026/0021683 A1
(43) Pub. Date: Jan. 22, 2026

(54) CONTROL ARRANGEMENT AND CONTROL METHOD FOR A LIGHTING SYSTEM OF A TRAILER VEHICLE

(71) Applicant: ZF CV Systems Global GmbH, Bern (CH)

(72) Inventors: Andreas Goers, Pattensen (DE); Jan-Christoph von der Beeke, Algermissen (DE); Axel Stender, Hameln (DE)

(21) Appl. No.: 19/346,195

(22) Filed: Sep. 30, 2025

Related U.S. Application Data
(63) Continuation of application No. PCT/EP2024/055715, filed on Mar. 5, 2024.

(30) Foreign Application Priority Data
Mar. 30, 2023 (DE) 10 2023 108 192.6

(51) Int. Cl. B60D 1/64; B60Q 1/30; B60Q 1/48; B60Q 1/50; B60Q 11/00; B60R 16/023; B60R 16/033; G07C 5/08

(52) U.S. Cl. CPC B60D 1/64; B60Q 1/305; B60Q 1/48; B60Q 1/543; B60Q 11/005; B60R 16/0231; B60R 16/033; G07C 5/0825; G07C 5/0833

(57) ABSTRACT

A control arrangement for controlling a lighting system of a trailer vehicle includes a central control unit that, when the trailer is coupled to a towing vehicle, is connected to a voltage source and to a towing vehicle control unit via a data bus cable, at least one electronic light control unit connected to the central control unit via a further data bus cable and to lighting units of the system. Data bus lines of the data bus cable and associated plug contacts of the plug connection form a first communication channel. Voltage supply lines of the data bus cables and associated plug contacts of the plug connection form a first voltage supply channel. To increase the operational reliability of the system and road safety of the trailer, the central control unit is connectable to the towing vehicle control unit via a redundant second communication channel.

### CROSS-REFERENCE TO RELATED APPLICATIONS

This application is a continuation application of international patent application PCT/EP2024/055715, filed Mar. 5, 2024, designating the United States and claiming priority from German application 10 2023 108 192.6, filed Mar. 30, 2023, and the entire content of both applications is incorporated herein by reference.

### TECHNICAL FIELD

The disclosure relates to a control arrangement for controlling a lighting system of a trailer vehicle, in particular a utility vehicle trailer, including a central electronic control unit that, in the state in which the trailer vehicle is coupled to a towing vehicle, is connected to a voltage source and to an electronic control unit of the towing vehicle via a data bus cable and a plug connection, and including at least one electronic light control unit that is connected to the central control unit via a data bus cable and to lighting units of the lighting system via a connection cable or connection contacts, wherein data bus lines of the data bus cable and associated plug contacts of the plug connection form a first communication channel, and voltage supply lines of the data bus cables and associated plug contacts of the plug connection form a first voltage supply channel. The disclosure furthermore relates to a control method for a lighting system of a utility vehicle trailer for operating such a control arrangement.

### BACKGROUND

The lighting system of a utility vehicle trailer usually includes the following, arranged at the rear of the vehicle: taillights, brake lamps, parking lamps, indicator lamps, rear fog lamps, reversing lamps, license plate lamps and position lamps. In addition, position lamps may also be arranged at the front of the trailer vehicle and side marking lamps may be arranged on the sides of the trailer vehicle. At least the taillights, the brake lamps, the parking lamps and the indicator lamps are usually combined into combination lamps that are configured as multi-chamber lamps.

In known lighting systems for utility vehicle trailers, such as tow-bar trailers and semitrailers, the lighting units are switched on and off from the associated towing vehicle. For this purpose, going from the towing vehicle to the abovementioned lighting units on the trailer vehicle, lines that are guided in a multi-wire cable harness are connected to or isolated from a voltage source via relays or electronic transistor circuits. These lines are in the form of at least one flexible connecting cable having plug connections at the ends thereof. In this case, lamps that are able to be switched on and off, such as taillights, license plate lamps and position lamps arranged at the rear of the vehicle, are usually connected laterally to a common line of the cable harness. The periodic actuation of the indicator lamps in the functions of direction indication, hazard lights, indicating locking status and indicating alarm system status is able to be controlled by way of flashing relays or electronic flashing circuits in the towing vehicle.

Due to the increasing number of installed electronic control units, electrical actuators, solenoid valves and sensors, cable harnesses are becoming increasingly extensive and complex, requiring a large number of copper lines and complicating the installation of the cable harnesses and, in the event of faults, making troubleshooting more difficult. Utility vehicles and their trailer vehicles are therefore increasingly being switched to control using electronic control units. This also applies to the lighting system of utility vehicle trailers, in which the functions of the lamps, that is, the switching on and off of the lamps and the flashing patterns of specific lamps, are controlled by way of at least one electronic light control unit (LCU). This light control unit receives control signals, which have been provided with an address code, from a controller arranged on the towing vehicle, via a data bus.

For instance, DE 10 2008 054 349 A1 discloses a number of embodiments of a control arrangement on a trailer vehicle, in which the brake system and the lighting system of the trailer vehicle are able to be controlled via data bus cables, an electronic brake control unit (BCU) and, partially, via an electronic light control unit (LCU). In a first variant embodiment of the control arrangement according to FIG. 1 in that document, a data bus cable containing supply lines and CAN (controller area network) bus data lines is routed from a socket on the vehicle front of the trailer vehicle to the brake control unit. A branched cable harness including individual lines or a branched data bus cable runs from the brake control unit to the lighting units of the trailer vehicle. In this embodiment, the brake control unit thus also carries out the function of a light control unit or of a gateway for controlling the lighting system of the trailer vehicle. A gateway function, to put it simply, enables communication between different data networks.

In a second embodiment of the control arrangement according to FIG. 2 in that document, a separate electronic light control unit is provided for the purpose of controlling the lighting system of the trailer vehicle, and is connected to the brake control unit via a second data bus cable and to the lighting units of the trailer vehicle via a further data bus cable or a cable harness including individual lines. The brake control unit thus likewise carries out the function of a gateway for the light control unit.

In a third embodiment of the control arrangement according to FIG. 3 in that document, the brake control unit and the light control unit are connected to the abovementioned front socket via a common data bus cable, and so a gateway function of the brake control unit is not present in that case. In a fourth embodiment of the control arrangement according to FIG. 4 in that document, the light control unit is connected directly to the front socket via a first data bus cable, and the brake control unit is connected to the light control unit via a second data bus cable, and so the light control unit here carries out the function of a gateway for the brake control unit.

That document additionally proposes an adapter using which the voltage supply, along with control data or control signals for controlling the brake system of the trailer vehicle, which are available from the towing vehicle via an ISO 7638 cable connector, and for controlling the lighting system of the trailer vehicle, which are available from the towing vehicle via an ISO 12098 cable connector, are converted and transformed into the plug format of the socket of the trailer vehicle.

DE 10 2010 018 127 A1 proposes a connecting device that is arranged fixedly on the vehicle front of a trailer vehicle and using which the voltage supply, along with control data or control signals for controlling the brake system of the trailer vehicle, which are present at an ISO 7638 socket, and for controlling the lighting system of the trailer vehicle, which are present at an ISO 12098 socket, are converted into the line formats of data bus cables that are routed to a brake control unit and to lighting units of the trailer vehicle. In a first embodiment of this control arrangement according to FIG. 1 in that document, a first data bus cable is routed from the connecting device to the brake control unit and two further data bus cables are routed laterally to the lighting units of the trailer vehicle, and so the connecting device in that case, in addition to the gateway function, also carries out the function of a light control unit. In a second embodiment of the control device according to FIG. 2 in that document, only one data bus cable is routed from the connecting device to the brake control unit, and the lighting units are connected to the brake control unit via a further, branched data bus cable, and so the brake control unit in that case additionally carries out the function of a light control unit.

DE 10 2018 007 092 A1 describes a rear light module intended to be mounted on the vehicle rear of a trailer vehicle. The rear light module has laterally arranged rear lamps including two taillights, two brake lamps and two indicator lamps, and an electronic light control unit and a battery. The light control unit is able to be actuated by and to communicate with the towing vehicle via a wired interface by way of a connection cable, and via a wireless interface by radio. Provision is made, in the event of a failure of the wired communication, for a warning message to be generated and sent wirelessly, that is, by radio, to the towing vehicle. If, in addition, the wireless communication fails as well, a warning light function, for example in the form of switched-on hazard lights, should be activated.

US2019217831A1 discloses an intelligent control unit, which may also have a gateway functionality, for a trailer vehicle.

### SUMMARY

It is an object of the disclosure to provide a control arrangement for controlling a lighting system of a vehicle, the control arrangement having further increased operational reliability. The intention is also to describe a control method for controlling a lighting system of a utility vehicle trailer with such a control arrangement, the operation of which achieves greater operational reliability of the lighting system and greater road safety of the utility vehicle trailer or of a vehicle combination formed from a towing vehicle and the utility vehicle trailer.

The solution to the device-related object is achieved by various control arrangements according to the disclosure.

The disclosure accordingly relates firstly to a control arrangement for controlling a lighting system of a trailer vehicle. According to an embodiment, the control arrangement for controlling a lighting system of a trailer vehicle includes
a central electronic control unit
that, in the state in which the trailer vehicle is coupled to a towing vehicle, is connected to a voltage source and to an electronic control unit of the towing vehicle via a data bus cable and a plug connection,
at least one electronic light control unit
that is connected to the trailer-side central control unit via a data bus cable and to lighting units of the lighting system via a connection cable or connection contacts,
wherein data bus lines of the data bus cable and associated plug contacts of the plug connection form a first communication channel,
and voltage supply lines of the data bus cables and associated plug contacts of the plug connection form a first voltage supply channel.

To achieve the device-related object, provision is furthermore made, in the case of this control arrangement,
that the central control unit of the trailer vehicle is able to be connected to the control unit of the towing vehicle via a redundant second communication channel,
and that the second communication channel includes at least two data bus lines and associated plug contacts
that are part of the data bus cable and of the plug connection between the control unit of the towing vehicle and the central control unit of the trailer vehicle.

The second communication channel, present in redundant form, increases the operational reliability of the lighting system of the trailer vehicle and thus the road safety of the vehicle combination formed from a towing vehicle and the trailer vehicle, since the communication path between the control unit of the towing vehicle and the central control unit of the trailer vehicle is able to be switched to the second communication channel following a failure of the first communication channel. It is thereby still possible to control the lighting system of the trailer vehicle using the control unit of the towing vehicle. Since the data bus lines and associated plug contacts of the second communication channel are integrated into the data bus cable and the plug connections between the control unit of the towing vehicle and the central control unit of the trailer vehicle, the additional outlay in terms of apparatus for the second communication channel is comparatively low.

To further improve the operational reliability of the lighting system of the trailer vehicle, provision may furthermore be made that the light control unit of the trailer vehicle is able to be connected to a voltage source of the towing vehicle or to a voltage source of the trailer vehicle via a redundant second voltage supply channel. The voltage supply to the light control unit and thus to the entire lighting system of the trailer vehicle is thus able to be switched to the second voltage supply channel following a failure of the first voltage supply channel, as a result of which at least a restricted functional scope of the lighting system of the trailer vehicle is ensured.

Provision may be made here that the second voltage supply channel includes at least two supply lines and plug contacts that are part of the data bus cable and of the plug connection between the control unit of the towing vehicle and the central control unit of the trailer vehicle, and of a data bus cable between the central control unit and the light control unit of the trailer vehicle. In this embodiment of the second voltage supply channel, the voltage supply to the lighting system of the trailer vehicle thus takes place from a voltage source of the towing vehicle via at least two supply lines and plug contacts, wherein the additional outlay in terms of apparatus is comparatively low as a result of the two additional supply lines and plug contacts.

The abovementioned supply lines of the second voltage supply channel may have smaller line cross sections than the supply lines of the first voltage supply channel, because the probability of failure of the first voltage supply channel is relatively low and the functional scope of the lighting system may be restricted when the second voltage supply channel is activated, this bringing about a lower electric current flow through the supply lines.

According to a second embodiment, which is an alternative thereto, provision may be made that the second voltage supply channel includes at least two supply lines that are part of a conventional connecting cable and of a plug connection between the control unit of the towing vehicle and the light control unit of the trailer vehicle. In this embodiment of the second voltage supply channel, the voltage supply to the lighting system of the trailer vehicle likewise takes place from a voltage source of the towing vehicle, but via another line path.

This conventional connecting cable and the associated plug connection may correspond to the ISO 12098 standard, which is widely used for controlling the lighting system of trailer vehicles, and may also be used as a backup for the communication channel between the control unit of the towing vehicle and the light control unit of the trailer vehicle.

According to an alternative third embodiment of the control arrangement, provision may be made that the second voltage supply channel includes at least two supply lines that are part of a charging and power supply cable arranged between an on-board electric battery of the trailer vehicle and the central control unit of the trailer vehicle, and of a data bus cable between the central control unit and the light control unit. In this embodiment of the second voltage supply channel, the voltage supply to the lighting system of the trailer vehicle takes place from the electric battery of the trailer vehicle, the electric battery acting as a voltage source and being able to be charged via the abovementioned charging and power supply cable and the central control unit when the first voltage supply channel is intact and used as a voltage supply to the lighting system when the first voltage supply channel has failed.

In order, in this variant, to enable a voltage supply to the lighting system that is independent of the central control unit of the trailer vehicle, provision may be made for a further voltage supply channel including at least two supply lines that are part of a separate power supply cable between the electric battery and the light control unit.

The light control unit of the trailer vehicle is preferably configured such that, in the case of at least one available voltage supply channel without an available communication channel, it brings about emergency operation of the lighting system that provides for at least continuous operation of the taillights. This control function may be realized by interconnecting electronic components of an electronic circuit, or may be part of the control program of the light control unit.

The light control unit of the trailer vehicle is additionally preferably configured such that, in the case of a voltage supply, via the second voltage supply channel, from an on-board battery without an available communication channel, it brings about energy-saving operation of the lighting system that provides for at least continuous operation of the parking lamps. This control function may be predefined by a control program of the light control unit or may be brought about by an electronic circuit in the light control unit, which is activated in the event of a failure of the first voltage supply channel.

The data bus cable and the associated plug connection between the control unit of the towing vehicle and the central control unit of the trailer vehicle and the data bus cable between the central control unit and the light control unit of the trailer vehicle are preferably in the form of Ethernet lines corresponding to the ISO 23870 standard, as a result of which a high bandwidth and a high data rate of the data communication are ensured.

The method-related object is achieved by various control methods according to the disclosure.

The disclosure accordingly relates to a method for controlling a lighting system of a trailer vehicle, including a control arrangement for controlling a lighting system, the control arrangement having a central electronic control unit that, in the state in which the trailer vehicle is coupled to a towing vehicle, is connected to a voltage source and to an electronic control unit of the towing vehicle via a data bus cable and an associated plug connection, and having at least one electronic light control unit that is connected to the central control unit via a data bus cable and to lighting units of the lighting system via a connection cable or connection contacts, wherein data bus lines of the data bus cable and the associated plug contacts of the plug connection form a first communication channel, and voltage supply lines of the data bus cables and the associated plug contacts of the plug connection form a first voltage supply channel.

To achieve the method-related object, provision is made, in this control method, that the communication between the control unit of the towing vehicle and the central control unit of the trailer vehicle is switched to a redundant second communication channel in the event of a failure of the first communication channel, and that, in this case, an error message is sent from the central control unit to the control unit of the towing vehicle and normal operation of the lighting system is continued.

Switching the communication between the control unit of the towing vehicle and the at least one control unit of the trailer vehicle from the first communication channel to the second communication channel maintains the ability to control the lighting system of the trailer vehicle using the control unit of the towing vehicle, as a result of which the road safety of the vehicle combination formed from the towing vehicle and the trailer vehicle is increased.

In order to further improve the operational reliability of the lighting system of the trailer vehicle, provision may also be made that the voltage supply to the light control unit is switched to a redundant second voltage supply channel in the event of a failure of the first voltage supply channel, and that, in this case, an error message is sent from the light control unit to the control unit of the towing vehicle.

In the case of an available voltage supply for the light control unit, following a failure of the available communication channel, provision is made that a warning light function of the lighting system is carried out for a limited period of time and emergency operation of the lighting system is performed thereafter. As a result, even in the case of interrupted communication with the central controller of the towing vehicle, a warning light function is able to be operated and emergency operation of the lighting system is able to be performed.

Provision may furthermore be made that, in the case of a voltage supply to the light control unit, via the second voltage supply channel, following a failure of the available communication channel, from an on-board electric battery, a warning light function of the lighting system is operated for a limited period of time and energy-saving operation of the lighting system is performed thereafter. Accordingly, even in the case of a complete interruption of the voltage supply by the towing vehicle, a warning light function and energy-saving operation of the lighting system are able to be performed by way of the battery arranged on the trailer vehicle.

The warning light function of the lighting system provides for at least flashing operation of the flashing lights of the trailer vehicle, which warns other road users. The emergency operation of the lighting system provides for at least continuous operation of the taillights of the trailer vehicle, which ensures sufficient illumination of the trailer vehicle and thus ensures the road safety of the vehicle combination. The energy-saving operation of the lighting system of the trailer vehicle provides for at least continuous operation of the parking lamps, which achieves minimum illumination of the trailer vehicle for as long as possible in the decoupled or detached state.

According to another embodiment of the control method, provision may be made that the reception of an error message from the central control unit or from the light control unit of the trailer vehicle in the control unit of the towing vehicle triggers the output of an acoustic or optical warning signal and/or the display of a warning text or a warning pictogram in a display and/or the storage of a corresponding error message in an error memory.

### BRIEF DESCRIPTION OF DRAWINGS

The invention will now be described with reference to the drawings wherein:

FIG. 1 shows a schematic view of a utility vehicle trailer including a first embodiment of a control arrangement according to the disclosure;

FIG. 2 shows a schematic view of a utility vehicle trailer including a second embodiment of a control arrangement according to the disclosure;

FIG. 3 shows a schematic view of a utility vehicle trailer including a third embodiment of a control arrangement according to the disclosure;

FIG. 4 shows a schematic view of a utility vehicle trailer including a fourth embodiment of a control arrangement according to the disclosure;

FIG. 5 shows control functions of the control method according to the disclosure, in the form of a table;

FIG. 6 shows control sequences of the control method according to the disclosure, in the form of a flowchart;

FIG. 7 shows further control sequences of the control method according to the disclosure, in the form of a flowchart; and,

FIG. 8 shows further control sequences of the control method according to the disclosure, in the form of a flowchart.

### DETAILED DESCRIPTION

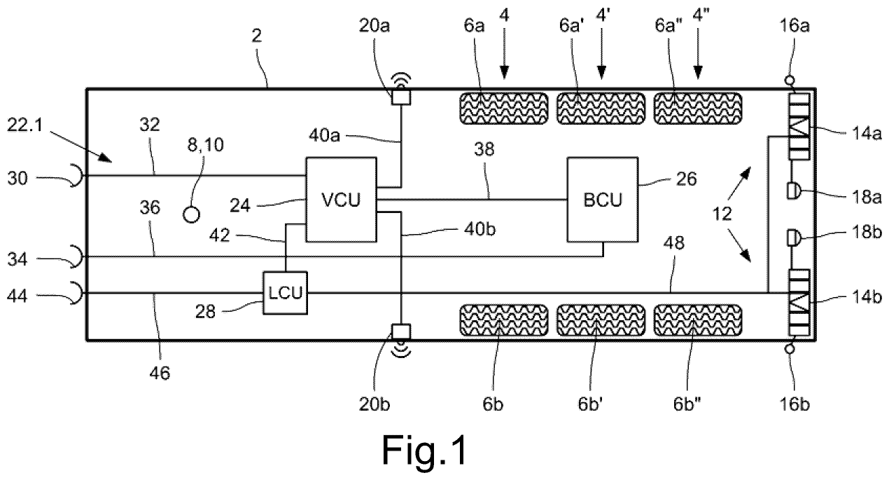

FIG. 1 accordingly schematically depicts a utility vehicle trailer 2 including a lighting system 12 and a control arrangement 22.1. In the present case, the trailer vehicle 2 is for example a semitrailer including three vehicle axles 4, 4′, 4″ and a semitrailer coupling 8. In a simplified manner, the vehicle axles 4, 4′, 4″ are depicted by their wheels 6a, 6b; 6a′, 6b′; 6a″, 6b″ and the semitrailer coupling 8 is depicted by its kingpin 10.

The lighting system 12 includes the following, arranged on both sides at the vehicle rear of the trailer vehicle 2: combination lamps 14a, 14b, position lamps 16a, 16b and license plate lamps 18a, 18b. The combination lamps 14a, 14b are configured as multi-chamber lamps and each have a rear lamp, a brake lamp, a parking lamp, an indicator lamp, a rear fog lamp and a reversing lamp. Moreover, a respective electronic camera 20a, 20b is arranged on both longitudinal sides of the trailer vehicle 2 and is able to record the surroundings of the trailer vehicle 2 and may be part of a parking assistance system or of a turning assistance system.

The control arrangement 22.1 depicted in FIG. 1 includes, as one embodiment, a central electronic control unit (VCU) 24, an electronic brake control unit (BCU) 26 and an electronic light control unit (LCU) 28. In the state in which the trailer vehicle 2 is coupled and electrically connected to a towing vehicle, not illustrated, the central control unit 24 is connected to an electronic control unit and to a voltage source of the towing vehicle via a first socket 30 and a first data bus cable 32. The first socket 30 and the first data bus cable 32 contain at least two plug contacts, respectively at least two data bus lines, which are part of a first communication channel between the control unit of the towing vehicle and the central control unit 24 of the trailer vehicle 2. The first socket 30 and the first data bus cable 32 additionally contain at least two plug contacts, respectively two voltage supply lines, which are part of a voltage supply channel between the voltage source of the towing vehicle and the central control unit 24 of the trailer vehicle 2. The data bus lines of the first data bus cable 32 are for example those of a high-speed Ethernet data bus in accordance with ISO 23870.

According to the disclosure, the first socket 30 and the first data bus cable 32 have at least two further plug contacts, respectively two further data bus lines, which are part of a second communication channel between the control unit of the towing vehicle and the central control unit 24 of the trailer vehicle 2. The communication between the control unit of the towing vehicle and the central control unit 24 of the trailer vehicle is thus able to be switched to the second communication channel in the event of a failure of the first communication channel, as a result of which the operational safety of the lighting system 12, and thus the road safety of the vehicle combination formed from the towing vehicle and the trailer vehicle, is increased.

The brake control unit 26 is connected to a towing vehicle-side electronic brake control unit and to a voltage source of the towing vehicle via a second socket 34 and a second data bus cable 36. The second socket 34 and the second data bus cable 36 may correspond to the ISO 7638 standard widely used for controlling an electronic brake system of a trailer vehicle. The brake control unit 26 is additionally connected to the central control unit 24 of the trailer vehicle 2 via a third data bus cable 38, as a result of which a direct exchange of sensor and control data between the central control unit 24 of the trailer vehicle 2 and the brake control unit 26 is possible.

The cameras 20a, 20b are also connected to the central control unit 24 via a respective data bus cable, namely via a fourth data bus cable 40a and a fifth data bus cable 40b, respectively. The data lines of the two last-mentioned data bus cables 40a, 40b may be LIN (LIN=local interconnect network) bus lines, since the LIN data bus is particularly suitable for transmitting audio and video signals.

The light control unit 28 is connected to the central control unit 24 via a sixth data bus cable 42, which preferably conforms with a high-speed Ethernet data bus in accordance with ISO 23870. The data bus lines of the first data bus cable 32 and of the sixth data bus cable 42 are thus part of a communication channel between the control unit of the towing vehicle 2 and the light control unit 28.

The light control unit 28 is additionally connected to the electronic control unit of the towing vehicle and to a voltage source of the towing vehicle via a socket 44 and a seventh data bus cable 46 of conventional configuration. The voltage supply lines of the first data bus cable 32 and of the sixth data bus cable 42 are parts of a first voltage supply channel between the voltage source of the towing vehicle and the light control unit 28. The voltage supply lines of the seventh data bus cable 46 are also parts of a second voltage supply channel between the voltage source of the towing vehicle and the light control unit 28.

The socket 44 and the associated seventh data bus cable 46 may be configured in accordance with the ISO 12098 standard widely used for controlling the lighting systems of utility vehicle trailers, in which the seventh data bus cable 46 contains three CAN bus lines (CAN-high, CAN-low, CAN-ground) in addition to two voltage supply lines.

The voltage supply lines of the seventh data bus cable 46 and the plug contacts of the associated socket 44 are, as already mentioned, part of a second voltage supply channel between the voltage source of the towing vehicle and the light control unit 28. In the event of a failure of the first voltage supply channel (first data bus cable 32, sixth data bus cable 42), the voltage supply to the light control unit 28 may thus be switched to the second voltage supply channel (seventh data bus cable 46), as a result of which the operational reliability of the lighting system 12, and thus the road safety of the vehicle combination, is increased.

The direct voltage supply to the light control unit 28 via the seventh data bus cable 46 also ensures that, in the case of a defect in the sixth data bus cable 42, which in fact also connects the light control unit 28 and the central control unit 24 of the trailer vehicle 2 to one another in terms of communication, the combination lamps 14a, 14b of the trailer vehicle 2 are supplied with a supply voltage that enables emergency operation or warning operation, and are also operated in this way. For this purpose, the electronic circuit of the light control unit 28 is configured such that, in the case of a defective sixth data bus cable 42, the light control unit 28 still enables a voltage supply to the combination lamps 14a, 14b of the trailer vehicle 2. In the case of a correct voltage supply to the light control unit 28 via the sixth data bus cable 42 and functioning communication between the light control unit 28 and the central control unit 24 of the trailer vehicle 2, the light control unit 28 actively switches off the emergency function just described and takes over normal operation of the lighting system 12.

The combination lamps 14a, 14b, to which the adjacent position lamps and license plate lamps 16a, 18a; 16b, 18b are also each electrically connected, are connected to the light control unit 28 via a multi-core connecting cable 48 that is branched at its ends, by way of which it is possible to control the switching on and off of the individual lamps and specific flashing patterns of some lamps.

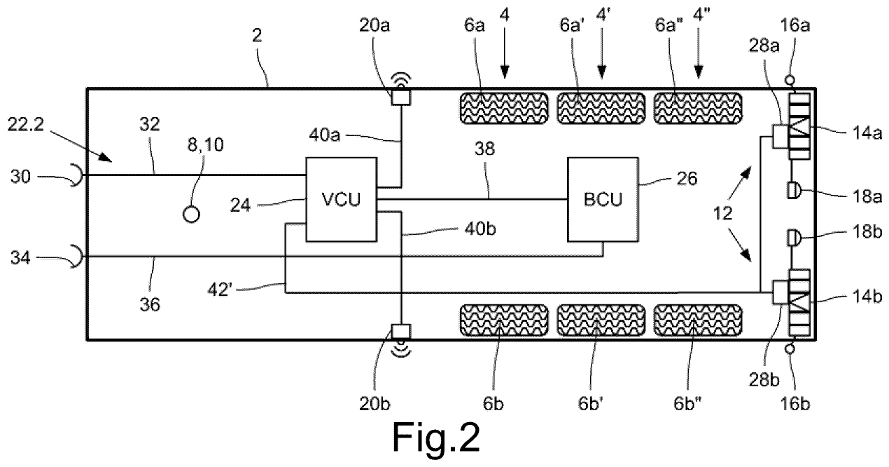

The second embodiment, depicted in FIG. 2, of a control arrangement 22.2 according to the disclosure differs from the first embodiment of the control arrangement 22.1 according to FIG. 1 in that two electronic light control units 28a, 28b are now present and are each arranged directly at the rear combination lamps 14a, 14b. These two light control units 28a, 28b are connected to the central control unit 24 via an eighth data bus cable 42′ that is branched at its ends and that is preferably configured as a high-speed Ethernet data bus in accordance with ISO 23870. Moreover, in this variant embodiment, there is no provision for a direct connection of the two light control units 28a, 28b to the electronic control unit and to a voltage source of the towing vehicle via a socket and a data bus cable of conventional configuration. In this variant embodiment, a second voltage supply channel for the two light control units 28a, 28b is formed by at least two additional plug contacts in the socket 30 and two additional voltage supply lines in the two data bus cables 32, 42′.

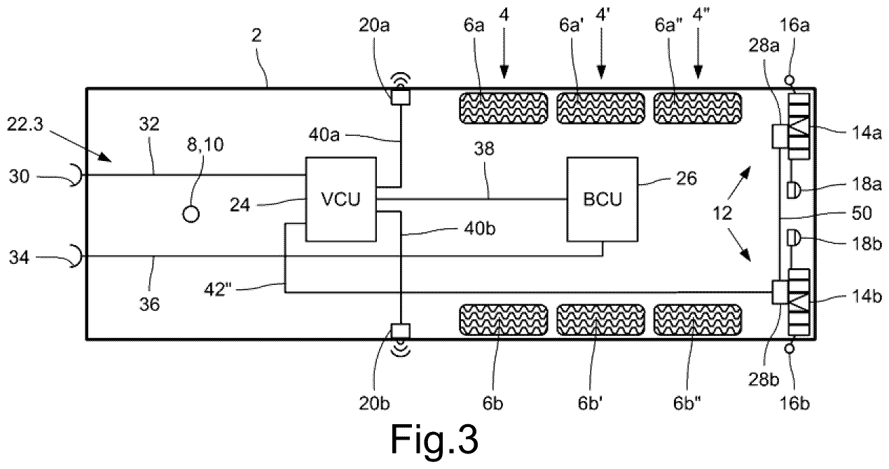

The third embodiment, depicted in FIG. 3, of the control arrangement 22.3 differs from the second embodiment of the control arrangement 22.2 according to FIG. 2 in that the left-hand light control unit 28b, in the direction of travel, is connected directly to the central control unit 24 via a ninth data bus cable 42″. The right-hand light control unit 28a, in the direction of travel, is connected to the left-hand light control unit 28b via a tenth data bus cable 50, the left-hand light control unit carrying out a gateway function for the right-hand light control unit 28a, that is, connecting the voltage supply through to the right-hand light control unit 28a and forwarding the control data thereto. Accordingly, both light control units 28a, 28b are connected to a first and single voltage supply channel.

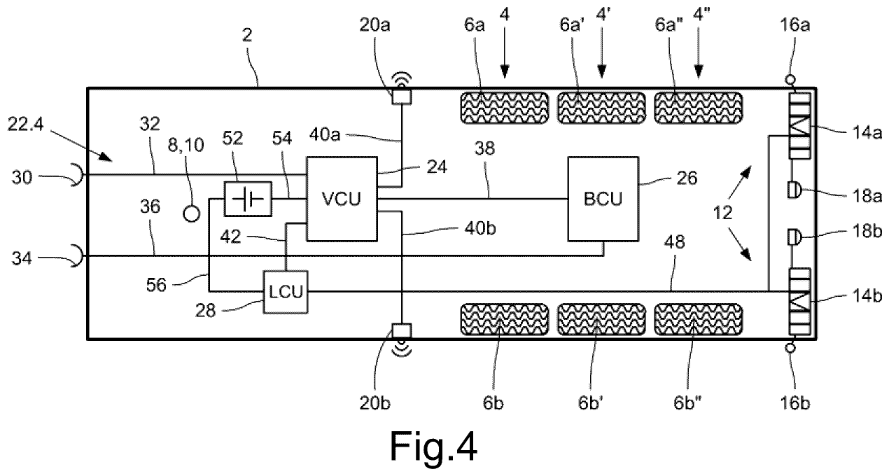

The fourth embodiment, depicted in FIG. 4, of the control arrangement 22.4 differs from the first embodiment of the control arrangement 22.1 according to FIG. 1 in that an on-board electric battery 52 is now arranged on the trailer vehicle 2 and is connected to the central control unit 24 via a charging and power supply cable 54. When the first voltage supply channel is available, the battery 52 is able to be charged via the central control unit 24 and the charging and power supply cable 54. In the case of a failed, that is, defective first voltage supply channel and a charged battery 52, the voltage supply to the light control unit 28 may take place via the charging and power supply cable 54 and via the sixth data bus cable 42 routed from the central control unit 24 to the light control unit 28, which thus form a second voltage supply channel. In order to enable a voltage supply to the lighting system 12 that is independent of the central control unit 24, the battery 52 is optionally connected directly to the light control unit 28 via a power supply cable 56. The power supply cable 56 thus creates a further voltage supply channel to which the voltage supply to the light control unit 28 and to the lighting system 12 may be switched as required.

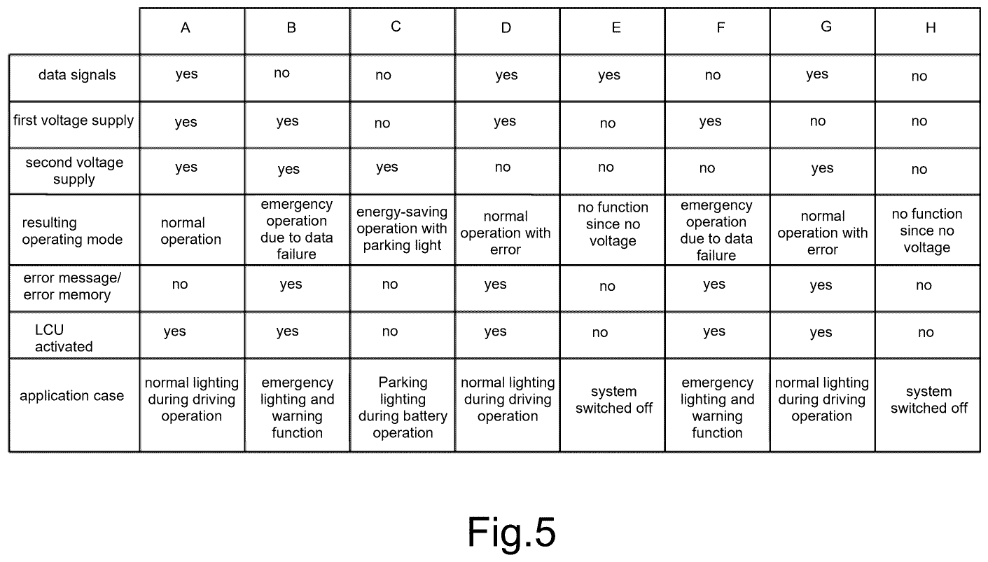

The table in FIG. 5 summarizes the most important control functions of the control method according to the disclosure for specific operating situations A to H, wherein applicable features are marked with a “yes” and non-applicable features are marked with a “no”.

When control data signals are available, that is, in the case of functioning data communication between the control unit of the towing vehicle and the light control unit 28 of the trailer vehicle 2, and functioning of both voltage supply channels (operating situation A), the light control unit 28 is activated and normal operation of the lighting system 12 takes place during driving operation.

In the case of failed data communication, but available voltage supply channels (operating situation B), the light control unit 28 is still activated and triggers emergency operation of the lighting system 12 with a warning light function that is effective for a limited period of time and continuous emergency operation. The warning light function of the lighting system 12 provides for at least flashing operation of the flashing lights, and the emergency operation of the lighting system 12 provides for at least continuous operation of the taillights. Furthermore, in this case, an error message may be output and is stored in an error memory of the central control unit 24 or of the light control unit 28.

In the case of failed data communication and a failed first voltage supply channel, but available voltage supply from an on-board battery 52 of the trailer vehicle 2 (operating situation C), the light control unit 28 is switched off and, in this state, causes energy-saving operation of the lighting system 12, which provides for at least continuous operation of the parking lamps or of the license plate lamps 18a, 18b or of the position lamps 16a, 16b.

In the case of available data communication and an available first voltage supply channel, but a failed second voltage supply channel (operating situation D), the active light control unit 28 sends an error message to the control unit of the towing vehicle and the lighting system 12 of the trailer vehicle 2 continues to be operated in normal operation.

If, in an operating situation E, both voltage supply channels have failed, operation of the light control unit 28 and of the lighting system 12 would not be possible, even in the case of available data communication. The system is therefore switched off.

In the case of failed data communication and a failed second voltage supply channel, but an available first voltage supply channel (operating situation F), the light control unit 28 is activated and triggers emergency operation of the lighting system 12 with a warning light function that is effective for a limited period of time and continuous emergency operation.

In the case of available data communication and an available second voltage supply channel, but a failed first voltage supply channel (operating situation G), the active light control unit 28 sends an error message to the control unit of the towing vehicle and the lighting system 12 of the trailer vehicle 2 continues to be operated in normal operation.

If both the data communication and the two voltage supply channels have failed, it is not possible to operate the light control unit 28 and the lighting system 12 (operating situation H).

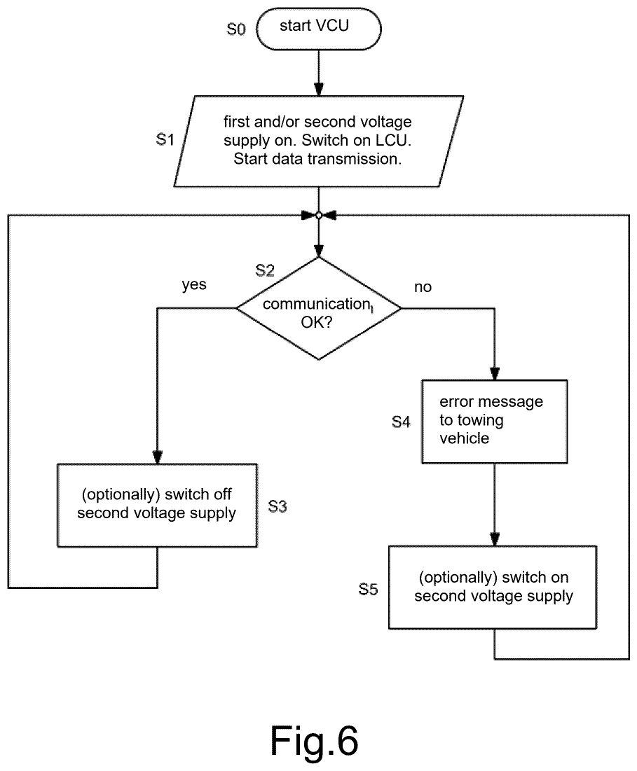

According to the flowchart, illustrated in FIG. 6, of the control method, following switching on S0 of the central control unit 24, the primary first voltage supply (first voltage supply channel) to the light control unit 28 is switched on in a first method step S1, such that the data communication between the light control unit 28 and the central control unit 24 begins. As an alternative thereto, the second voltage supply (second voltage supply channel) may be switched on. A check is then carried out in the light control unit 28 to determine whether the data communication is functioning (method step S2). In the case of a positive check result, the optionally switched-on second voltage supply is switched off (method step S3) and the method branches back to before the check query (S2). In the case of a negative check query, an error message is sent from the light control unit 28 to the control unit of the towing vehicle (method step S4) and the second voltage supply is switched on (method step S5) if it was not already switched on beforehand. The method then branches back to before the check query (S2). The check query (S2) and the result-dependent program loops (S3 or S4, S5) are run through in a fixed cycle when the light control unit 28 is switched on.

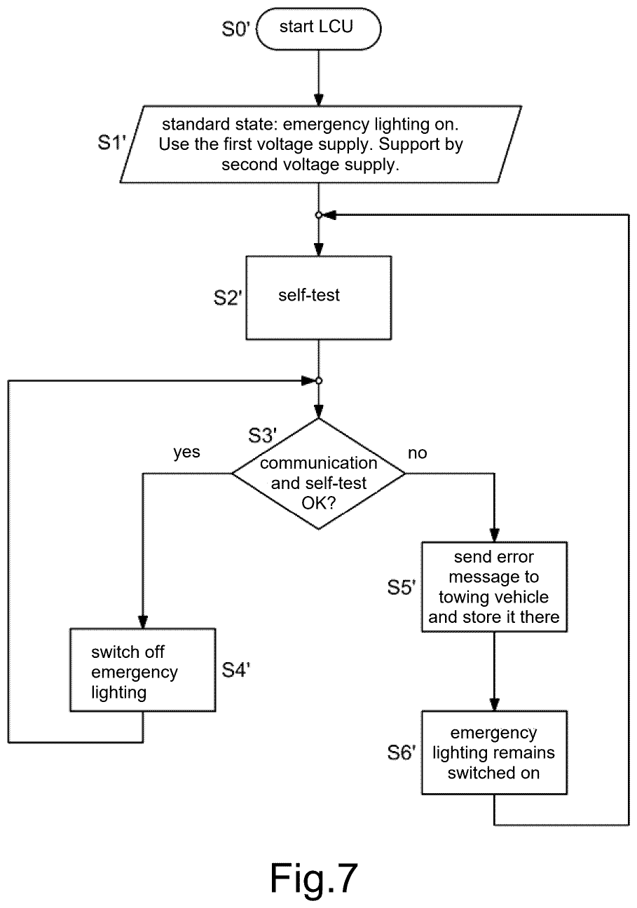

According to the flowchart, illustrated in FIG. 7, of the control method, after the light control unit 28 has been switched on (S0′), a standard state is first defined (method step S1′), which provides for switched-on emergency lighting (emergency operation of the lighting system 12), a voltage supply to the light control unit 28 via the primary first voltage supply (first voltage supply channel) and possible support by the redundant second voltage supply (second voltage supply channel). A self-test is then performed (method step S2′) and a check is subsequently carried out to determine whether the data communication is functioning and the self-test has produced a positive result (method step S3′). In the case of a positive check result, the emergency lighting is switched off (method step S4′) and the method branches back to before the check query (S3′). In the case of a negative check result, an error message is sent from the light control unit 28 to the control unit of the towing vehicle and stored in an error memory (method step S5′). The emergency lighting then remains switched on (method step S6′) and the method branches back to before the self-test (S2′). The self-test (S2′) and/or the check query (S3′) and the result-dependent program loops (S4′ or S5′, S6′) are run through in a fixed cycle when the light control unit (LCU) 28 is switched on.

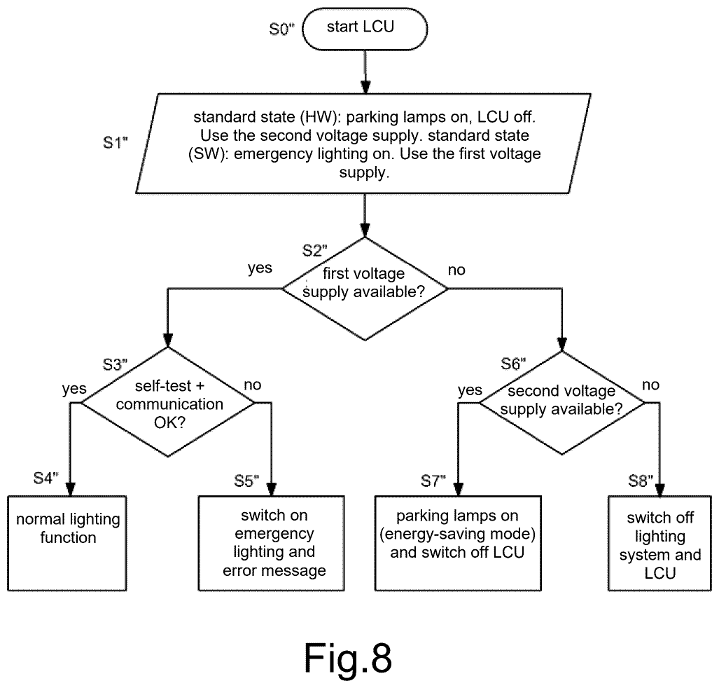

According to the flowchart, illustrated in FIG. 8, of the control method, after the light control unit 28 has been switched on S0″, a standard state is first defined (method step S1″) which provides for parking lamps (energy-saving operation of the lighting system 12) that are switched on with regard to the hardware HW, a switched-off light control unit 28 and a voltage supply via the redundant second voltage supply (second voltage supply channel). With regard to the software SW, activated emergency lighting (emergency operation of the lighting system 12) and a voltage supply to the light control unit 28 via the primary first voltage supply (first voltage supply channel) are provided for in this standard state. A check is then carried out in a method step S2″ to determine whether the first voltage supply is available.

In the case of a positive check result, a check is carried out to determine whether the data communication is functioning and a previously performed self-test has a positive result (method step S3″). In the case of a positive test result, a normal lighting function (normal operation of the lighting system 12) is performed (method step S4″). In the case of a negative check result, the emergency lighting (emergency operation of the lighting system 12) is switched on and an error message is sent from the light control unit 28 to the control unit of the towing vehicle (method step S5″).

In the case of a negative check result to the first check query S2″, a check is then carried out to determine whether the second voltage supply (second voltage supply channel) is available (method step S6″). In the case of a positive check result, the parking lamps are switched on (energy-saving operation of the lighting system 12) and the light control unit 28 is switched off (method step S7″). In the case of a negative check result, the entire lighting system 12 and the light control unit 28 are switched off (method step S8″).

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

2 utility vehicle trailer, trailer vehicle
4, 4′, 4″ vehicle axles
6a, 6b wheels
6a′, 6b′ wheels
6a″, 6b″ wheels
8 semitrailer coupling
10 kingpin
12 lighting system
14a, 14b combination lamps, multi-chamber lamps, lighting units
16a, 16b position lamps, lighting units
18a, 18b license plate lamps, lighting units
20a, 20b cameras
22.1 control arrangement (first embodiment)
22.2 control arrangement (second embodiment)
22.3 control arrangement (third embodiment)
22.4 control arrangement (fourth embodiment)
24 central control unit, VCU
26 brake control unit, BCU
28 light control unit, LCU
28a, 28b rear light control units
30 socket
32 first data bus cable
34 socket
36 second data bus cable
38 third data bus cable
40a fourth data bus cable
40b fifth data bus cable
42 sixth data bus cable
42″ eighth data bus cable
42″ ninth data bus cable
44 socket
46 seventh data bus cable
48 connection cable
50 tenth data bus cable
52 battery
54 charging and power supply cable
56 power supply cable
A to H different operating situations
BCU brake control unit
HW hardware
LCU light control unit
S0-S5 method steps
S0′-S6′ method steps
S0″-S8″ method steps
SW software
VCU vehicle control unit, central control unit

1. A control arrangement for controlling a lighting system of a trailer vehicle, the control arrangement comprising:
a central electronic control unit that, in a state in which the trailer vehicle is coupled to a towing vehicle, is connected to a voltage source and to an electronic control unit of the towing vehicle via a data bus cable and a plug connection;
at least one electronic light control unit connected to the central electronic control unit via a further data bus cable and to a plurality of lighting units of the lighting system via a connection cable or connection contacts;
wherein data bus lines of the data bus cable and associated plug contacts of the plug connection form a first communication channel, and voltage supply lines of the data bus cable and further data bus cable and the associated plug contacts of the plug connection form a first voltage supply channel; and,
the central electronic control unit of the trailer vehicle being configured to be connected to the electronic control unit of the towing vehicle via a redundant second communication channel, wherein the second communication channel includes at least two data bus lines and associated plug contacts that are part of the data bus cable and of the plug connection between the electronic control unit of the towing vehicle and the central electronic control unit of the trailer vehicle.

2. The control arrangement of claim 1, wherein the light control unit of the trailer vehicle is configured to be connected to a voltage source of the towing vehicle or to a voltage source of the trailer vehicle via a redundant second voltage supply channel.

3. The control arrangement of claim 2, wherein the second voltage supply channel includes at least two supply lines and plug contacts that are part of the data bus cable and of the plug connection between the electronic control unit of the towing vehicle and the central electronic control unit of the trailer vehicle, and of the further data bus cable between the central electronic control unit and the light control unit of the trailer vehicle.

4. The control arrangement of claim 2, wherein the supply lines of the second voltage supply channel have smaller line cross sections than the supply lines of the first voltage supply channel.

5. The control arrangement of claim 2, wherein the second voltage supply channel includes at least two supply lines that are part of a conventional connecting cable and of a further plug connection between the electronic control unit of the towing vehicle and the light control unit of the trailer vehicle.

6. The control arrangement of claim 5, wherein the conventional connecting cable and the associated further plug connection between the electronic control unit of the towing vehicle and the light control unit of the trailer vehicle correspond to an ISO 12098 standard.

7. The control arrangement of claim 2, wherein the second voltage supply channel includes at least two supply lines that are part of a charging and power supply cable arranged between an on-board battery of the trailer vehicle and the central electronic control unit of the trailer vehicle, and of the further data bus cable between the central electronic control unit and the light control unit.

8. The control arrangement of claim 7, wherein a further voltage supply channel is provided and includes at least two supply lines that are part of a separate power supply cable between the on-board battery and the light control unit.

9. The control arrangement of claim 1, wherein the light control unit of the trailer vehicle is configured such that, in a case of at least one available voltage supply channel without an available communication channel, the light control unit of the trailer vehicle brings about emergency operation of the lighting system that provides for at least continuous operation of taillights.

10. The control arrangement of claim 2, wherein the light control unit of the trailer vehicle is configured such that, in a case of a voltage supply, via the second voltage supply channel, from an on-board battery without an available communication channel, the light control unit of the trailer vehicle brings about energy-saving operation of the lighting system that provides for at least continuous operation of parking lamps.

11. The control arrangement of claim 1, wherein the data bus cable and the associated plug connection between the electronic control unit of the towing vehicle and the central electronic control unit of the trailer vehicle and the further data bus cable between the central electronic control unit and the light control unit of the trailer vehicle are in the form of Ethernet lines corresponding to an ISO 23870 standard.

12. A method for controlling a lighting system of a trailer vehicle, the lighting system including a control arrangement for controlling the lighting system, the control arrangement having a central electronic control unit that, in a state in which the trailer vehicle is coupled to a towing vehicle, is connected to a voltage source and to an electronic control unit of the towing vehicle via a data bus cable and an associated plug connection, the control arrangement further having at least one electronic light control unit connected to the central electronic control unit via a further data bus cable and to lighting units of the lighting system via a connection cable or connection contacts, wherein data bus lines of the data bus cable and associated plug contacts of the plug connection form a first communication channel, and voltage supply lines of the data bus cable and the further data bus cable and associated plug contacts of the plug connection form a first voltage supply channel, the method comprising:
switching the communication between the electronic control unit of the towing vehicle and the central electronic control unit of the trailer vehicle to a redundant second communication channel in an event of a failure of the first communication channel; and,
in the event of the failure of the first communication channel, sending an error message from the central electronic control unit to the electronic control unit of the towing vehicle and continuing normal operation of the lighting system.

13. The method of claim 12 further comprising switching the voltage supply to the light control unit to a redundant second voltage supply channel in an event of a failure of the first voltage supply channel; and, in the event of the failure of the first voltage supply channel, sending an error message from the light control unit to the electronic control unit of the towing vehicle.

14. The method of claim 12 further comprising, in a case of an available voltage supply to the light control unit, following the failure of an available communication channel, carrying out a warning light function of the lighting system for a limited period of time and performing emergency operation of the lighting system thereafter.

15. The method of claim 13 further comprising, in the case of the voltage supply to the light control unit via the second voltage supply channel, following the failure of an available communication channel, from an on-board battery, carrying out a warning light function of the lighting system for a limited period of time and performing an energy-saving operation of the lighting system thereafter.

16. The method of claim 14, wherein the warning light function of the lighting system provides for at least flashing operation of flashing lights, in that the emergency operation of the lighting system provides for at least continuous operation of taillights; and, the energy-saving operation of the lighting system provides for at least continuous operation of parking lamps.

17. The method of claim 15, wherein the warning light function of the lighting system provides for at least flashing operation of flashing lights, in that the emergency operation of the lighting system provides for at least continuous operation of taillights; and, the energy-saving operation of the lighting system provides for at least continuous operation of parking lamps.

18. The method of claim 12, wherein a reception of the error message from the central electronic control unit or from the light control unit of the trailer vehicle in the electronic control unit of the towing vehicle triggers at least one of outputting of an acoustic or optical warning signal, displaying of a warning text or a warning pictogram in a display, storing of a corresponding error message in an error memory.
